(19) United States
(12) Patent Application Publication
(10) Pub. No.: US 2009/0210323 A1
(43) Pub. Date: Aug. 20, 2009

(54) Distributed Purchasing System for User Generated Content and/or Products/Services Advertised Through User Generated Content

(75) Inventor: Dennis Mendiola, New York, NY (US)

Correspondence Address: INTELLECTUAL PROPERTY LAW GROUP LLP, 12 SOUTH FIRST STREET, SUITE 1205, SAN JOSE, CA, 95113, US

(73) Assignee: VOXP PTE. LTD., Singapore (SG)

(21) Appl. No.: 12/371,566

(22) Filed: Feb. 13, 2009

Related U.S. Application Data
(60) Provisional application No. 61/065,547, filed on Feb. 13, 2008.

(51) Int. Cl. G06Q 30/00; G06Q 50/00; G06Q 20/00

(52) U.S. Cl. 705/27

(57) ABSTRACT

A purchasing system comprising a user and a purchasing server wherein the user provides electronic content to the purchasing server. The purchasing server operates to create a unique code for the electronic content and create an altered version of the electronic content having the unique code embedded therein. The altered version of the electronic content is returned to the user who can distribute it through any electronic media system. On receipt of a communication from a purchaser containing the unique code, the purchasing server provides a copy of, or directions on accessing a copy of, the original electronic content to the purchaser. The purchaser is then charged for purchasing the original electronic content. In a further variation of this system, the purchaser may purchase goods or services depicted in the electronic content and differentiated by a unique code displayed in the altered electronic content rather than purchasing the electronic content.

### CROSS-REFERENCE TO RELATED APPLICATION

This application claims benefit of priority to U.S. Provisional Application No. 61/065,547 filed on Feb. 13, 2008, the entire contents of which are herein incorporated by reference.

### FIELD OF THE INVENTION

The invention relates to a distributed purchasing system for user generated content and/or products/services advertised through user generated content. The invention is particularly suited to facilitating the purchase of electronic user generated content marketed through a variety of electronic media.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

User generated content (“UGC”) is now prevalent throughout the Internet. Sites such as Youtube (www.youtube.com), Facebook (www.facebook.com) and MySpace (www.myspace.com) have grown successful primarily through UGC. However, the business success of these sites is related to the advertising that such sites can provide and not the UGC itself.

Further, in most cases, the users who generate the UGC receive no remuneration for their efforts.

It is therefore an object of the present invention to provide users with a mechanism by which their UGC, displayed through any electronic media, may be purchased by third parties.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a purchasing system comprising:
a user; and
a purchasing server
   where when the user provides electronic content to the purchasing server, the purchasing server operates to create a unique code for the electronic content and create an altered version of the electronic content having the unique code embedded therein, the altered version of the electronic content being returned to the user who can distribute it through any electronic media system, the purchasing server further operable, on receipt of a communication from a purchaser containing the unique code, to provide a copy of, or directions on how to access to a copy of, the original electronic content to the purchaser and charge the purchaser for the original electronic content.

The alteration process may degrade the quality of the electronic content and/or omit a portion of the electronic content.

The purchaser can provide details of the intended playback device for the electronic content in the communication and the purchasing server modifies, if necessary, the original electronic content so as to enable playback of the original electronic content on the specified playback device.

In accordance with a second aspect of the present invention there is a purchasing system comprising:
a user; and
a purchasing server
   where when the user provides electronic content to the purchasing server, the purchasing server operates to create a unique code for each product or service described in the electronic content and create an altered version of the electronic content having each unique code embedded therein, the altered version of the electronic content being returned to the user who can distribute it through any electronic media system, the purchasing server further operable, on receipt of a communication from a purchaser containing one of the unique codes embedded in the electronic content, to provide details of how to redeem the good or service associated with that unique code to the purchaser and charge the purchaser for good or service.

In respect of both the first and second aspects of the invention, the following modifications may be provided.

The purchaser may be charged for their purchase by way of a premium SMS message sent to the purchaser containing the original content or details of how to redeem the original content, good or service, as appropriate.

The electronic media system can be one of the following: a mass e-mail; a website; an electronic forum.

The alteration process may also involve embedding into the electronic code the cost associated with each unique code, the cost being the cost to purchase the content, good or service, as appropriate, associated with the unique code.

The user, at the time of providing the electronic content, may be requested to specify at least one of the following other items of information: the amount the purchaser should be charged for the electronic content, good or service (as appropriate); the category or categories in which the electronic content should be grouped; the type of electronic content; the date of publication of the electronic content.

The amount the purchaser is charged for the electronic content, good or service (as appropriate) may include a commission for an operator of the purchasing server.

The amount the purchaser is charged for the electronic content, good or service (as appropriate) may include a commission for an operator of the electronic media system, the purchasing server further operable to make payment to the operator of the electronic media system following.

On receipt of the communication from the purchaser, the purchasing server may ensure that any access controls set in respect of the associated electronic content, product or service are satisfied before providing the electronic content, product or service (as appropriate) to the purchaser.

Payment for the electronic content, good or service (as appropriate) can be made by way of an account the purchaser has with an operator of the purchasing server.

The purchaser may specify in the communication the medium and address for delivery of the electronic content, product and service (as appropriate) and the purchasing server operates to provide, or enable redemption, of the electronic content, good or service through such medium and address.

In accordance with a third aspect of the present invention there is a method for purchasing electronic content comprising the steps of
receiving electronic content from a user;
creating a unique code for the electronic content;
creating an altered version of the electronic content having the unique code embedded therein;
returning the altered electronic content to the user for distribution through one or more electronic media systems of the user's choice;
receiving a communication from a purchaser containing the unique code;
providing a copy of the original electronic content, or direction on how to access a copy of the original electronic content associated with the unique code, to the purchaser; and
charging the purchaser for the original electronic content so provided.

In accordance with a fourth aspect of the present invention there is a method for purchasing a good or service displayed by way of electronic content comprising the steps of:
receiving the electronic content from a user;
creating a unique code for each good or service described in the electronic content;
creating an altered version of the electronic content having each unique code created embedded therein;
returning the altered electronic content to the user for distribution through one or more electronic media systems of the user's choice;
receiving a communication from a purchaser containing one of the unique codes created;
providing directions on how to redeem the good or service associated with the unique code to the purchaser; and
charging the purchaser for the good or service so provided.

In accordance with further aspects of the present invention there are purchasing servers and executable software stored on a processor-readable medium for effecting the methods as described above. Yet further aspects of the invention related to electronic content delivered in accordance with the method of the third aspect of the invention.

These and other embodiments of the present invention are further made apparent, in the remainder of the present document, to those of ordinary skill in the art.

### BRIEF DESCRIPTION OF THE DRAWINGS

The invention will now be described, by way of example only, with reference to the accompanying drawings, in which:

FIG. 1 is a schematic representation according to an embodiment of the present invention.

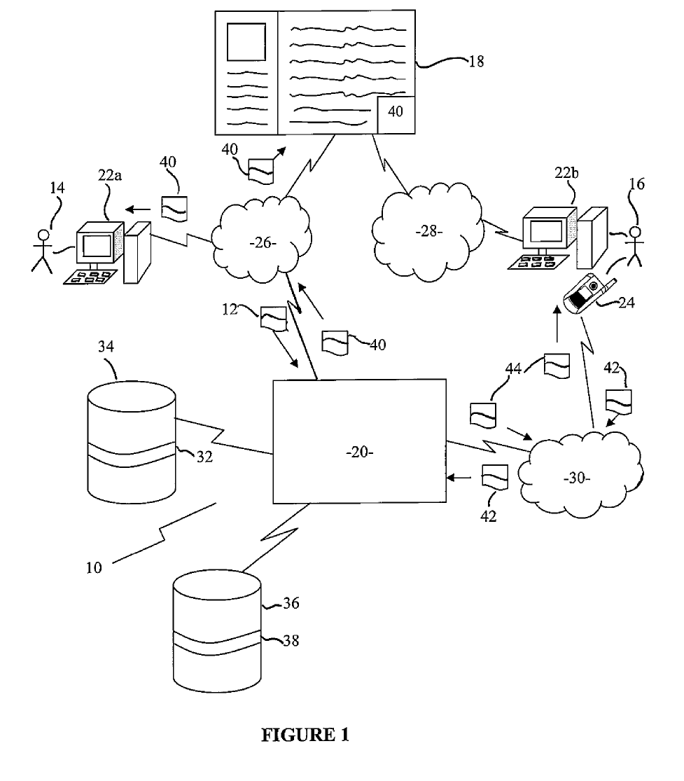

### SPECIFIC EMBODIMENTS OF THE INVENTION

In accordance with a first embodiment of the invention there is a distributed purchasing system 10 for UGC 12. The distributed purchasing system 10 comprises a user 14, a purchaser 16, a UGC website 18 and a purchasing server 20.

The user 14 and purchaser 16 are each associated with a computer 22. The purchaser 16 is also associated with a mobile phone 24.

The computer 22a associated with the user 14 is able to communicate with the purchasing server 20 and the UGC website 18 through a first computer network 26. The computer 22a associated with the purchaser is able to communicate with the UGC website 18 through a second computer network 28. In this embodiment, the first computer network 26 and the second computer network 28 are the Internet.

The purchasing server 20 is able to receive messages from the mobile phone 24 by way of mobile telecommunication network 30.

This embodiment of the invention will now be described in the context of its intended operation.

The user 14 accesses the purchasing server 20 using an appropriate program on their computer 22a (such as an Internet browser, or remote terminal program). Once an access connection has been established, the user 14 is requested to register their details with the purchasing server 20 if they have not already done so.

The user 14 registers their personal, financial and contact details by completing a registration form (not shown) displayed by the accessing program on computer 22a as per programming instructions provided by purchasing server 20. Once the personal, financial and contact details have been properly entered into the registration form, the user 14 initiates the communication of such details to the purchasing server 20 by way of a control button (not shown). The purchasing server 20, on receipt of these details generates initial authentication information for the user 14. The combination of the initial authentication information and the details received by the purchasing server 20 are then combined into a user record 32. The user record 32 is stored in a registered user database 34.

After storing the user record 32, the purchasing server 20 conveys the generated initial authentication information for the user 14 so that they may access main functionality of the purchasing server 20 directly in future.

By contrast, if the user 14 has already registered their details, then the user is simply required to enter in their username and authentication information. The user 14 is then directly connected to the main functionality of the purchasing server 20.

Once identification and authentication of the user 14 has been completed, the purchasing server 20 operates to provide a menu of choices to the user 14. In this embodiment, the menu (not shown) provides a choice of uploading a new UGC 12 or changing the terms of an existing uploaded UGC 12.

For the purposes of this example, the user 14 chooses to upload a new UGC 12.

On choosing to upload a new UGC 12, the user 14 is presented with a further form (not shown). This new form asks the user 14 for details of the type of UGC 12 to be uploaded (for instance, photo, video, audio) and how much the user 14 wishes to charge people who wish to purchase this UGC 12. Once this information has been entered, the user 12 is instructed to select the file representing the UGC 12 from a storage device (not shown) connected to, or forming part of, their computer 22a for upload. Once selected, the user 12 is instructed to activate a further control button (not shown) to initiate the upload of the selected file to the purchasing server 20. Once uploaded, the purchasing server 20 generates a unique code for the UGC 12. The purchasing server 20 then combines the unique code, type and price information with the UGC file into a UGC record 36. The UGC record 36 is then stored in a UGC database 38.

Following storage of the UGC record 36 in the UGC database 38, the purchasing server 20 initiates an alteration sequence with respect of the uploaded UGC 12. The alteration sequence differs according to the type of UGC 12 uploaded. For instance, for photos and video, the alteration sequence involves slightly blurring the photograph or video the subject of the UGC 12. Similarly, for audio, the file is converted to a monaural (in the case of stereo files) and/or the quality of the audio file the subject of the UGC 12 is downgraded. Irrespective, the UGC 12 as altered by the alteration sequence is embodied as a separate altered UGC 40.

The altered UGC 40 is then subjected to a watermarking process. The watermarking process sees the embedding of the unique code of the original UGC 12 into the altered UGC 40. For instance, in the case of video or photos, this may be by way of visual depiction of the code across the video/photo. In the case of audio, this may be by way of an audible representation of the code being said over the top of the sounds contained in the audio file.

The altered UGC 40, now including the embedded watermark, is then returned to the user 14. In this embodiment, this is done as part of an initiated download, for which the user 14 is required to save the altered UGC 40 to a storage device connected to, or forming part of, their computer 22a.

Having received the altered UGC 40, the user 14 is then free to upload the altered UGC 40 by any electronic media system he or she wishes to. For instance, the user 14 may send out a mass e-mail to third parties containing the altered UGC 40. Alternatively, the user 14 may upload the altered UGC 40 to their personal portion of a social network site (not shown). In this embodiment, the user 14 uploads the altered UGC 40 to UGC website 18.

Once uploaded to the UGC website 18, the altered UGC 42 is available for public inspection by third parties.

When a third party, such as purchaser 16, wishes to purchase a UGC 12, they take note of the unique code embedded as the watermark in the corresponding altered UGC 40. The purchaser 16 then uses their associated mobile phone 24 to send a SMS message 42 containing this unique code to a shortcode associated with purchasing server 20.

The purchasing server 20, on receiving the SMS message 42 by way of the shortcode, parses the SMS message 42 to identify the mobile phone number of the sender and the unique code contained in the message. Having identified the unique code contained in the SMS message 42, the purchasing server 20 cross-references the unique code with the UGC records 36 contained in the UGC database 38 until a match is identified. Once identified, the purchasing server 20 formulates a new message 44 including the original UGC 12 associated with the matching record. This new message 44 is then sent to the mobile phone number identified from the SMS message 42 as a premium message. The cost of the new message 44 is equal to the amount specified by the user 14 as indicated in the matching record.

Once the purchaser 16 has been provided with the original UGC 12 and charged for it, the purchasing server 20 accesses the user record 32 of the author of the UGC 12 (i.e. user 14). The accessed user record 32 provides the financial details of the user 13 which allow the purchasing server 20 to make payment for the provision of the UGC 12 to the author. Payment is then instructed to be made to the user 14 by the purchasing server 20 in line with such financial details.

It should be appreciated by the person skilled in the art that the above invention is not limited to the embodiment(s) described. In particular, the following modifications and improvements may be made without departing from the scope of the present invention:
The UGC 12 may be classified or categorised by either the purchasing server 12 or the user 14. Certain categories of UGC 12, such as adult-oriented or religious related material, may have access-control restrictions placed on it. Alternatively, such access-control restrictions may be enforced through the electronic media through which the UGC 12 is advertised.
The alteration sequence applied to the UGC 12 may differ from that described above. For instance, the alteration sequence may blanket out part or all of the UGC 12. In the case of a photograph or video, this may be achieved by defining a black region within the photograph or video. In the case of audio files, this may be achieved by eliminating all sound during a portion of the file.
In addition to providing a unique code in the UGC 12 as part of the watermarking process, the watermarking process may also include details of the price to purchase the UGC 12.
The price charged to the purchaser 16 for the UGC 12 may be the price set by the user 14 plus the addition of commissions or other service charges imposed by the operation of the purchasing server 20. Similarly, the electronic media through which the UGC 12 is made available may impose its own charges in respect of the UGC 12, collection and distribution of which is achieved by way of the purchasing server 20.
The purchaser 16 need not be provided with the UGC 12 as part of a text message. Instead, the purchaser 16 may be provided with a weblink to a location where the UGC 12 can be obtained as a download or provided as a datastream.
In respect of certain UGC 12, such as audio files or ringtones, the purchaser 14 may be required to provide details of the device on which they plan on viewing/listening to the UGC 12. In this manner, the UGC 12 provided to the purchaser 14 may be tailored to meet the technical restrictions of the specified device (if any).
While the system 10 has been described herein in the context of the Internet, it need not be so restricted. For instance, the system can easily operate within an Intranet or private computer network system.
As mentioned above, the user 14 may be presented with the option of amending the details in respect of a UGC 12 upon logging onto the purchasing server 20. In this manner, the user 14 can change the price of any uploaded UGC 12 at any time. Alternatively, the user 14 can amend a record such that the UGC 12 is no longer available for purchase.
The user 14 may be required to enter in the date of creation of the UGC 12 as part of the registration information. In this manner, the date of expiry of the copyright in the UGC 12 can be tracked and uncopyrighted works can then be made freely available to the public by the purchasing server 20 without need of payment to the user 14.
Rather than the user 14 providing financial information to the purchasing server 20 in order to obtain payment for their UGC 12 purchased by other parties, the purchasing server 20 may operate on an account basis. In this manner, at periodic intervals, the user 14 may be provided with a statement of the purchases of each UGC 12 they have with the payment server 20 and the fees payable to the purchasing server 20 for handling such purchases. The balance of the statement may then be forwarded to the user 14 as a cheque (or other similar financial instrument) for the user 14 to do with as they wish.
A user 14 may provide registration details by way of a mobile communications device (for example, their mobile phone or PDA) as an alternative, or in addition to, being able to register through a computer network.
The purchaser 16 may specify the delivery medium and delivery address for the purchased UGC 12 as part of SMS message 42.
Similarly, the purchaser may include the unique code of the UGC 12 they wish to purchase as part of the phone number to which SMS message 42 is addressed. For instance, this can be done by suffixing the unique code to a shortcode operated by the purchasing server 20. Alternatively, the unique code may be appended to a phone number operated by the purchasing server 20 and delineated by a separator key (such as the “*” or “#” symbols).
In place of the purchaser 16 paying for the UGC 12 by way of the premium SMS message 44, the purchasing server 20 may operate an account for the purchaser 16. Payment for all UGC 12 purchasers made on the account during a defined time period can then be initiated by the purchasing server 20 at the end of that period.
Users 12 may be “paid” in credit that can be used to purchaser other UGC 12 provided by the purchasing server 20 rather than being paid to a bank account or similar monetary account.
Users 12 may also be paid in terms of mobile phone credit. In this situation, the user 12 need not enter in financial details, instead merely specifying their mobile phone number if not otherwise ascertainable from communications between the purchasing server 20 and the user 12.

Those of ordinary skill in the art would recognize variations, modifications, and alternatives. Such variations, modifications, and alternatives are also within the scope of the present invention. The scope of the present invention, for the purpose of the present patent document, is not limited merely to the specific example embodiments or alternatives of the foregoing description.

1. A purchasing system comprising:
a user; and
a purchasing server
where when the user provides electronic content to the purchasing server, the purchasing server operates to create a unique code for the electronic content and create an altered version of the electronic content having the unique code embedded therein, the altered version of the electronic content being returned to the user who can distribute it through any electronic media system, the purchasing server further operable, on receipt of a communication from a purchaser containing the unique code, to provide a copy of, or directions on how to access to a copy of, the original electronic content to the purchaser and charge the purchaser for the original electronic content.

2. A purchasing system according to claim 1, where the alteration process degrades the quality of the electronic content and/or omits a portion of the electronic content.

3. A purchasing system according to claim 1 or claim 2, where the purchaser provides details of the intended playback device for the electronic content in the communication and the purchasing server modifies, if necessary, the original electronic content so as to enable playback of the original electronic content on the specified playback device.

4. A purchasing system comprising:
a user; and
a purchasing server
where when the user provides electronic content to the purchasing server, the purchasing server operates to create a unique code for each product or service described in the electronic content and create an altered version of the electronic content having each unique code embedded therein, the altered version of the electronic content being returned to the user who can distribute it through any electronic media system, the purchasing server further operable, on receipt of a communication from a purchaser containing one of the unique codes embedded in the electronic content, to provide details of how to redeem the good or service associated with that unique code to the purchaser and charge the purchaser for good or service.

5. A purchasing system according to claim 1 or claim 4, where the purchaser is charged for their purchase by way of a premium SMS message sent to the purchaser containing the original content or details of how to redeem the original content, good or service, as appropriate.

6. A purchasing system according to claim 1 or claim 4, where the electronic media system is one of the following: a mass e-mail; a website; an electronic forum.

7. A purchasing system according to claim 1 or claim 4, where the alteration process further includes embedding into the electronic code the cost associated with each unique code, the cost being the cost to purchase the content, good or service, as appropriate, associated with the unique code.

8. A purchasing system according to claim 1 or claim 4, where the user, at the time of providing the electronic content, also specified at least one of the following other items of information: the amount the purchaser should be charged for the electronic content, good or service (as appropriate); the category or categories in which the electronic content should be grouped; the type of electronic content; the date of publication of the electronic content.

9. A purchasing system according to claim 1 or claim 4, where the amount the purchaser is charged for the electronic content, good or service (as appropriate) includes a commission for an operator of the purchasing server.

10. A purchasing system according to claim 1 or claim 4, where the amount the purchaser is charged for the electronic content, good or service (as appropriate) includes a commission for an operator of the electronic media system, the purchasing server further operable to make payment to the operator of the electronic media system following.

11. A purchasing system according to claim 1 or claim 4, where, on receipt of the communication from the purchaser, the purchasing server ensures that any access controls set in respect of the associated electronic content, product or service are satisfied before providing the electronic content, product or service (as appropriate) to the purchaser.

12. A purchasing system according to claim 1 or claim 4, where payment for the electronic content, good or service (as appropriate) is made by way of an account the purchaser has with an operator of the purchasing server.

13. A purchasing system according to claim 1 or claim 4, where the purchaser specified in the communication the medium and address for delivery of the electronic content, product and service (as appropriate) and the purchasing server operates to provide, or enable redemption, of the electronic content, good or service through such medium and address.

14. A method for purchasing electronic content comprising the steps of
receiving electronic content from a user;
creating a unique code for the electronic content;
creating an altered version of the electronic content having the unique code embedded therein;
returning the altered electronic content to the user for distribution through one or more electronic media systems of the user's choice;
receiving a communication from a purchaser containing the unique code;
providing a copy of the original electronic content, or direction on how to access a copy of the original electronic content associated with the unique code, to the purchaser; and
charging the purchaser for the original electronic content so provided.

15. A method for purchasing a good or service displayed by way of electronic content comprising the steps of:
receiving the electronic content from a user;
creating a unique code for each good or service described in the electronic content;
creating an altered version of the electronic content having each unique code created embedded therein;
returning the altered electronic content to the user for distribution through one or more electronic media systems of the user's choice;
receiving a communication from a purchaser containing one of the unique codes created;
providing directions on how to redeem the good or service associated with the unique code to the purchaser; and
charging the purchaser for the good or service so provided.
